(19) United States
(12) Patent Application Publication
(10) Pub. No.: US 2019/0365090 A1
(43) Pub. Date: Dec. 5, 2019

(54) PORTABLE HEIGHT ADJUSTABLE TABLE

(71) Applicant: Regency Seating, Inc., Akron, OH (US)

(72) Inventors: William OAKLEY, Akron, OH (US); John Summerville, Uniontown, OH (US)

(73) Assignee: Regency Seating, Inc., Akron, OH (US)

(21) Appl. No.: 16/428,187

(22) Filed: May 31, 2019

Related U.S. Application Data
(60) Provisional application No. 62/679,504, filed on Jun. 1, 2018.

(51) Int. Cl. A47B 9/20; B60B 33/00

(52) U.S. Cl. CPC A47B 9/20; B60B 33/0078; A47B 2200/006; A47B 2200/12; A47B 2200/0062

(57) ABSTRACT

It is described herein a table which may comprise a panel (100), a first extendable leg (200), a second extendable leg (300), a first foot (400), a second foot (500), and a control assembly (600). The first extendable leg may be connected at a first end to a bottom surface of the panel adjacent to a first edge of the panel. The second extendable leg may be connected at a first end to the bottom surface of the panel adjacent to a second edge of the panel opposite the first edge of the panel. The first extendable leg may be connected at a second end to a top surface of the first foot. The second extendable leg may be connected at a second end to a top surface of the second foot. The first foot may further comprise a pair of first casters connected to a bottom surface of the first foot. The second foot may further comprise a pair of second casters connected to a bottom surface of the second foot. At least one of the first extendable leg and the second extendable leg may further comprise a linear actuator electrically connected to a battery of the control assembly.

### CROSS REFERENCES AND PRIORITIES

This Application claims priority from U.S. Provisional Application No. 62/679,504 filed on 1 Jun. 2018, the teachings of which are incorporated by reference herein in their entirety.

### BACKGROUND

Height adjustable tables are frequently used in office and home settings as workstations, particularly computer and laptop workstations. The ability to vary table height based on the height and posture of the user, or based on the task the user is engaged in (working on a computer, reading a book, etc.) is considered desirable. Recently, adjustable tables and workstations which allow the user to choose between working in a seated position or working in a standing position have become popular. Additionally, users often prefer mobile workstations which can be easily moved to different locations within the user's workspace.

Height adjustable tables exist which rely upon scissor assemblies to adjust the table height. One example is shown in United States Patent Application Publication No. 2015/0216296 which discloses, “[a] work surface height adjustment apparatus having a work surface platform and a scissors assembly mounted to a platform. The scissors assembly has horizontal cross members, a scissors linkage mounted to the horizontal cross members, a control link mounted to the scissors linkage and a horizontal cross member. When extended, the scissors linkage creates two identical and opposing isosceles triangles.”

Other height adjustable tables exist which allow the user to adjust the table height using a hand crank attached to a series of gears, chains and/or screws to extend or retract the table legs. One example is shown in US. Pat. No. 5,845,590 which discloses that, “[i]n operation, the height of table top 12 is adjusted by the operator first manually engaging crank 106 with the upper end of drive shaft 98. The operator then turns crank 106 to rotate drive sprocket 96, which in turn imparts rotation to driven sprockets 92 and 112 through chains 108 and 110, respectively.” Other examples of hand crank driven height adjustable tables include U.S. Pat. No. 8,256,359 and 4,515,087.

More recently, attempts have been made to utilize electronically controlled telescoping linear actuators in place of the traditional hand cranks to extend or retract table legs. One example of such a device is shown in U.S. Pat. No. 6,494,005 which discloses, “[a] motorized telescopic leg assembly comprising: an outer tubular leg; an inner tubular leg telescopically fitted within said outer leg; and a drive assembly mounted within said inner and outer tubes, said drive assembly including: a base plate; a drive nut riser tube extending from said base plate; a drive nut mounted to an end of said riser tube remote from said base plate; a drive screw threadably extending into said drive nut and extendable into said riser tube; and a motor fitted within said inner leg and having a shaft coupled to said drive screw for rotating said drive screw for extending and retracting the inner leg with respect to the outer leg.”

The purpose of the device disclosed herein is to provide an improved table which allows the user to easily adjust the table height while also allowing the user to easily move the table within the confines of the user's workspace.

### SUMMARY

It is disclosed herein a table which may comprise a panel, a first extendable leg, a second extendable leg, a first foot having a first pair of casters, a second foot having a second pair of casters, a control assembly and a linear actuator.

The panel may comprise a first edge, a second edge opposite the first edge, a third edge extending from the first edge to the second edge, and a fourth edge opposite the third edge and extending from the first edge to the second edge. The panel may also comprise a top surface and a bottom surface opposite the top surface.

The first extendable leg may have a first extendable leg first end and a first extendable leg second end opposite the first extendable leg first end. Similarly, the second extendable leg may have a second extendable leg first end and a second extendable leg second end opposite the second extendable leg first end.

The first foot may have a first foot first end, a first foot second end opposite the first foot first end, a first foot top surface, and a first foot bottom surface. The first pair of casters may be connected to the first foot bottom surface and located at the first foot first end and the first foot second end respectively.

Similarly, the second foot may have a second foot first end, a second foot second end opposite the second foot first end, a second foot top surface, and a second foot bottom surface. The second pair of casters may be connected to the second foot bottom surface and located at the second foot first end and the second foot second end respectively.

The control assembly may comprise a battery, a plurality of capacitive touch keys, and a printed circuit board electrically connected to the battery wherein the plurality of capacitive touch keys are arranged on the printed circuit board. At least one of the first extendable leg and the second extendable leg may comprise a linear actuator electrically connected to the battery.

The first extendable leg first end may be connected to the bottom surface adjacent to the first edge. Similarly, the second extendable leg first end may be connected to the bottom surface adjacent to the second edge.

The first extendable leg second end may be connected to the first foot top surface. Similarly, the second extendable leg second end may be connected to the second foot top surface.

It is further disclosed that at least one of the first pair of casters may comprise a first lock mechanism. It is also disclosed that at least one of the second pair of casters may comprise a second lock mechanism.

It is also disclosed that the table may comprise a modesty panel spanning a distance between the first extendable leg and the second extendable leg.

It is further disclosed that the linear actuator may comprise an anti-collision device programmed by the control box.

It is also disclosed that each of the first extendable leg and the second extendable leg may comprise a separate linear actuator electrically connected to the battery.

It is further disclosed that the first extendable leg and the second extendable leg may each be a two stage telescopic leg. It is also disclosed that the linear actuator may comprise a first motor.

It is further disclosed that the first extendable leg and the second extendable leg may each be a three stage telescopic leg. It is also disclosed that the linear actuator may comprise a first motor and a second motor.

It is further disclosed that the table may comprise a third extendable leg which may have a third extendable leg first end and a third extendable leg second end opposite the third extendable leg first end wherein the third extendable leg first end may be connected to the bottom surface adjacent to the third edge. It is also disclosed that the table may further comprise a third foot which may have a third foot first end, a third foot second end opposite the third foot first end, a third foot top surface, a third foot bottom surface, and a third pair of casters which may be connected to the third foot bottom surface and may be located at the third foot first end and the third foot second end respectively wherein the third extendable leg second end may be connected to the third foot top surface.

Also disclosed herein is a table kit comprising a panel, a first extendable leg, a second extendable leg, a first foot, a second foot, a first pair of casters, a second pair of casters, and a control assembly which may comprise a battery, a plurality of capacitive touch keys, and a printed circuit board electrically connected to the battery. In the table kit, at least one of the first extendable leg and the second extendable leg may comprise a linear actuator, and the plurality of capacitive touch keys may be arranged on the printed circuit board.

It is also disclosed that each of the first extendable leg and the second extendable leg of the table kit may comprise a separate linear actuator.

It is also disclosed that at least one of the first pair of casters of the table kit may comprise a first lock mechanism. It is further disclosed that at least one of the second pair of casters of the table kit may comprise a second lock mechanism.

It is also disclosed that the first extendable leg and the second extendable leg of the table kit may each be a two stage telescopic leg. It is further disclosed that the first extendable leg and the second extendable leg of the table kit may each be a three stage telescopic leg.

It is also disclosed that the table kit may comprise a modesty panel.

It is further disclosed that linear actuator of the table kit may comprise an anti-collision device.

### BRIEF DESCRIPTION OF FIGURES

FIG. 1 is a perspective view of an embodiment of a table in a lowered position as described herein.

FIG. 2 is a perspective view of an embodiment of a table in a raised position as described herein.

FIG. 3 is a front view of the embodiment of a table shown in FIG. 2.

FIG. 4 is a bottom view of an embodiment of a table as described herein.

FIG. 5 is a close-up perspective view of an embodiment of a control assembly for a table as described herein.

FIG. 6 is a close-up perspective view of an embodiment of a foot for a table as described herein.

FIG. 7 is a front view of an embodiment of a table in a raised position as described herein.

FIG. 8A is a perspective view of the embodiment of a table shown in FIG. 7.

FIG. 8B is a perspective view of an embodiment of a table in an partially extended position as described herein.

FIG. 8C is a perspective view of an embodiment of a table in a lowered position as described herein.

FIG. 9 is a perspective view of an embodiment of a table having a modesty panel as described herein.

FIG. 10 is a front perspective view of an embodiment of a table having a modesty panel as described herein.

FIG. 11 is an exploded perspective view of an embodiment of a table as described herein.

### DETAILED DESCRIPTION

This invention is to an improved table which allows a user to easily adjust the table height while also allowing the user to easily move the table within the confines of the user's workspace. Reference will now be made to the various Figures in which, unless otherwise noted, like numbers refer to like structures. As described herein and in the claims, the following numbers refer to the following structures as noted in the Figures.

10 refers to a table.

100 refers to a panel.

110 refers to a first edge of the panel.

120 refers to a second edge of the panel.

130 refers to a third edge of the panel.

140 refers to a fourth edge of the panel.

150 refers to a top surface of the panel.

160 refers to a bottom surface of the panel.

200 refers to a first extendable leg.

210 refers to a first extendable leg first end.

220 refers to a first extendable leg second end.

300 refers to a second extendable leg.

310 refers to a second extendable leg first end.

320 refers to a second extendable leg second end.

400 refers to a first foot.

410 refers to a first foot first end.

420 refers to a first foot second end.

430 refers to a first foot top surface.

440 refers to a first foot bottom surface.

450A and 450B refer to a first pair of casters.

455 refers to a first lock mechanism.

500 refers to a second foot.

510 refers to a second foot first end.

520 refers to a second foot second end.

530 refers to a second foot top surface.

540 refers to a second foot bottom surface.

550A and 550B refer to a second pair of casters.

555 refers to a second lock mechanism.

600 refers to a control assembly.

620 refers to a plurality of capacitive touch keys.

700 refers to a modesty panel.

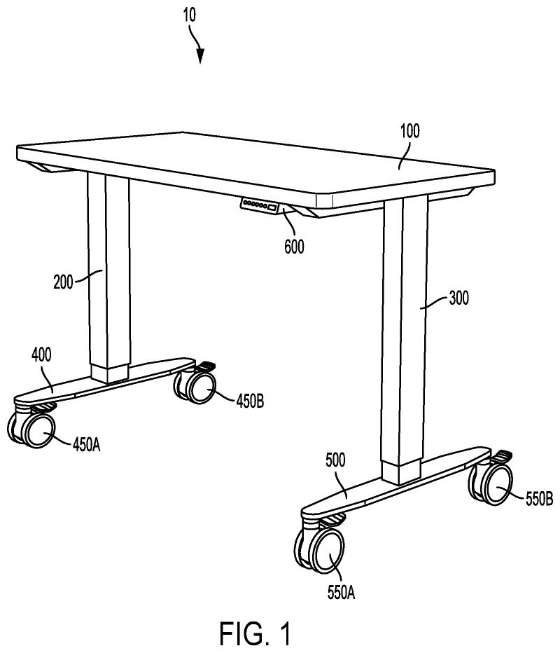

As depicted in FIG. 1, the table (10) comprises a panel (100), a first extendable leg (200), a second extendable leg (300), a first foot (400) having a first pair of casters (450A and 450B), a second foot (500) having a second pair of casters (550A and 550B), and a control assembly (600). A preferred embodiment of an extendable leg, which may be either a first extendable leg or a second extendable leg, is a telescoping leg made of at least a first section longitudinally nested inside a second section. FIG. 1 depicts one embodiment of the table in which the first extendable leg and the second extendable leg are two stage legs. In other words, each of the first extendable leg and the second extendable leg are made of a first section longitudinally nested inside a second section.

At least one of the first extendable leg (200) and/or the second extendable leg (300) may comprise a linear actuator. In some embodiments, each of the first extendable leg and the second extendable leg may comprise a separate linear actuator. The linear actuator can either extend or retract upon receiving a corresponding electrical signal from the control assembly (600). In some embodiments, particularly those where the first extendable leg and the second extendable leg are telescopic legs having two stages (i.e. two stage legs), the linear actuator will comprise a first motor which drives the extension or retraction of the first section of the telescopic leg relative to the second section. In other embodiments, particularly those where the first extendable leg and the second extendable leg are telescopic legs having three stages (i.e. three stage legs), the linear actuator will comprise a first motor and a second motor. In such embodiments, the first motor may drive the extension or retraction of the first section of the telescopic leg relative to the second section while the second motor may drive the extension or retraction of the second section of the telescopic leg relative to the third section. The linear actuator may function in much the same manner as a garage door opener. In some embodiments, the linear actuator may comprise a series of pulleys. In some embodiments, the linear actuator may comprise a series of gears and screws. In still other embodiments, the linear actuator may comprise a hydraulic cylinder or a compressed air cylinder.

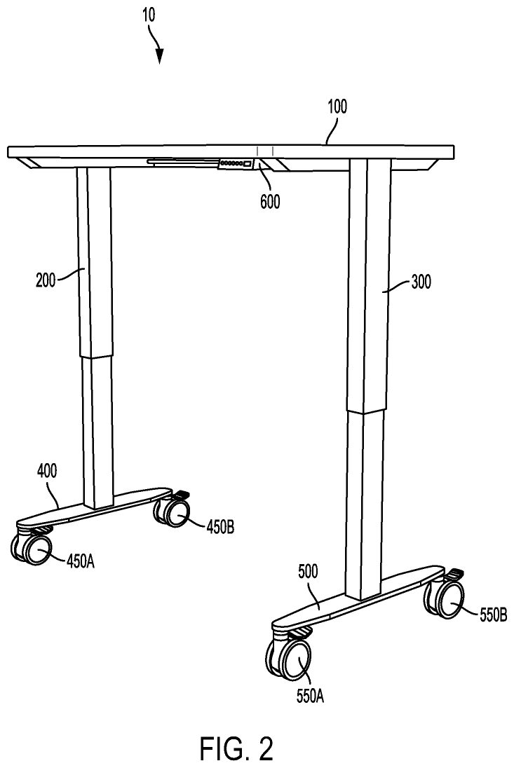

FIG. 1 shows the first extendable leg (200) and the second extendable leg (300) in a fully retracted position, also known as a lowered position. In FIG. 1, the second section of the two stage telescopic legs is fully nested inside the first section. FIG. 2 shows the first extendable leg and the second extendable leg in a fully extended position, also known as a raised position. In FIG. 2, the second section of the two stage telescopic legs is fully extended from the first section. One of ordinary skill will recognize that the first extendable leg and the second extendable leg can be in any number of intermediate positions between the fully retracted position and the fully extended position by interrupting the electrical signal between the linear actuator(s) and the control assembly at any point when the linear actuator is not fully extended but is also not fully retracted.

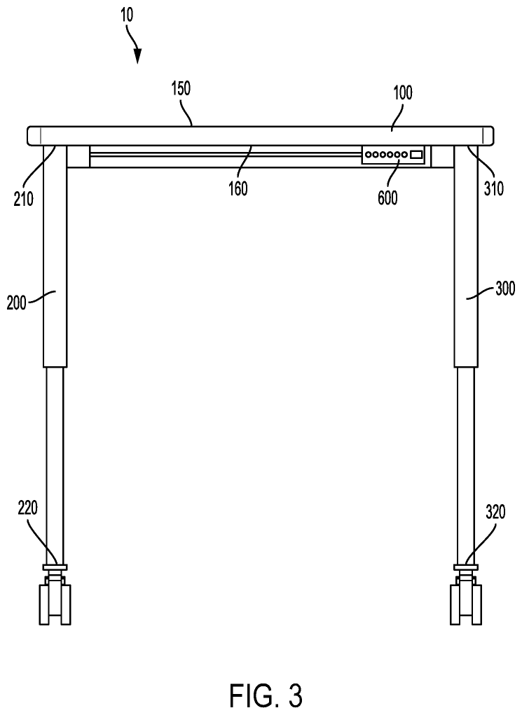

FIG. 3 shows a front view of the table (10) in the fully extended position. FIG. 3 also shows the first extendable leg first end (210), and the first extendable leg second end (220), as well as the second extendable leg first end (310), and the second extendable leg second end (320). Also shown in FIG. 3 is the top surface (150) of the panel and the bottom surface (160) of the panel. As shown in FIG. 3, the first extendable leg first end is connected to the bottom surface of the panel. Similarly, the second extendable leg first end is also connected to the bottom surface of the panel.

As used herein and in the claims, the term “connected” means that one component is joined to another component in a non-permanent fashion, such as by a fastener. By way of example, but not limitation, such fasteners may include a bolt (and in some examples a corresponding nut), a screw, and a cam-lock device. Two components being connected to one another differs from two components being attached to one another. As used herein and in the claims, the term “attached” means that one component is joined to another component in a permanent fashion, such as by welding the two components together or manufacturing the two components from one integral piece of material.

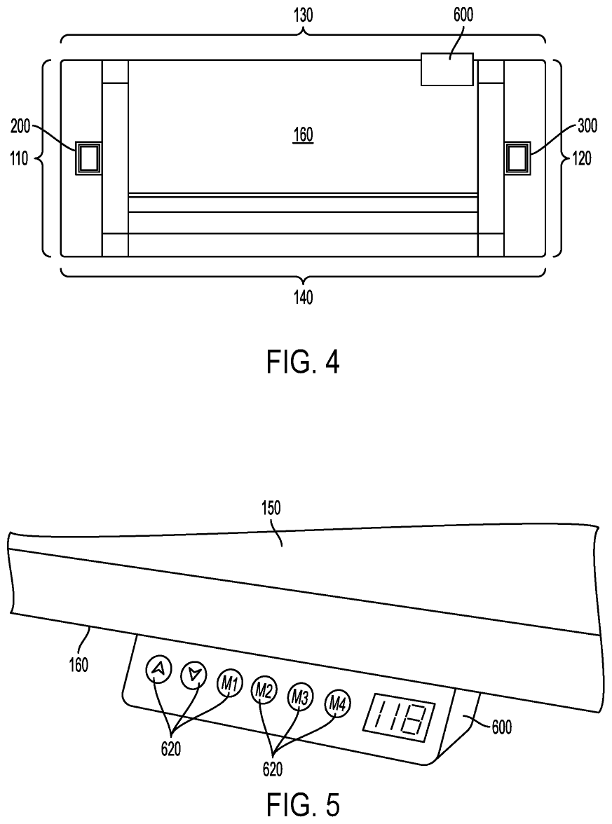

FIG. 4 shows a bottom view of the table. As shown in FIG. 4, the panel (100) comprises a first edge (110), and a second edge (120) which is opposite the first edge. The panel also comprises a third edge (130) extending from the first edge to the second edge. The panel further comprises a fourth edge (140) extending from the first edge to the second edge opposite the third edge. As shown in FIG. 4, the first extendable leg (200) and the second extendable leg (300) are each connected to the bottom surface (160) of the panel. As shown in FIG. 4, the first extendable leg may be connected to the bottom surface of the panel proximate to the first edge while the second extendable leg may be connected to the bottom surface of the panel proximate to the second edge.

Although shown in the Figures as a rectangular shaped panel, the panel can take many shapes. In some embodiments, the panel may have a three sided polygon shape—i.e. a triangular shaped panel. In some embodiments, the panel may have a four sided polygon shape—i.e. a square shaped panel, a rectangular shaped panel, a trapezoidal shaped panel, or a rhombus shaped panel. In still other embodiments, the panel may have a five sided polygon shape—i.e. a pentagonal shaped panel. In other embodiments, the panel may have a six sided polygon shape—i.e. a hexagonal shaped panel. In yet other embodiment, the panel may have a seven sided polygon shape—i.e. a heptagonal shaped panel. In some embodiments, the panel may have an eight sided polygon shape—i.e. an octagonal shaped panel. In some embodiments, the panel may have a circle or ellipse shape—i.e. a circular shaped panel or an elliptical shaped panel.

FIG. 5 shows a close-up view of the control assembly (600). As shown in FIG. 5, the control assembly comprises a plurality of capacitive touch keys (620). These capacitive touch keys are arranged on a printed circuit board, which is electrically connected to a battery. The battery may then be electrically connected to the linear actuator(s). As used herein and in the claims, the term “electrically connected” means that two or more components are linked by a cable, wire, or other device capable of transmitting an electrical current between the components.

In practice, when an operator presses one of the capacitive touch keys, the printed circuit board sends a signal to the battery to transmit an electrical current to one or more motors of one or more linear actuators. The signal may be to turn the motor(s) in a first direction to extend the linear actuator(s) or in a second direction to retract the linear actuator(s) depending upon which of the capacitive touch keys the operator presses. When the operator ceases pressing the capacitive touch key, the signal is interrupted and the battery ceases to transmit electrical current to the motor(s).

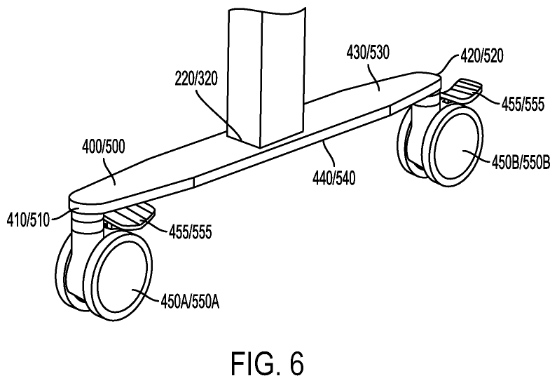

FIG. 6 shows a close-up view of a foot connected to or attached to a telescopic leg. The foot may be either a first foot (400) or a second foot (500), and the telescopic leg may be either a first extendable leg (200) or a second extendable leg (300). As shown in FIG. 6, the foot has a first end (410 for the first foot or 510 for the second foot), a second end (420 for the first foot and 520 for the second foot) opposite the first end, a top surface (430 for the first foot and 530 for the second foot), and a bottom surface (440 for the first foot and 540 for the second foot). The foot may also have a pair of casters. The pair of casters may include a first caster (450A for the first foot and 550A for the second foot) and a second caster (450B for the first foot and 550B for the second foot).

As shown in FIG. 6, the foot may be attached to or connected to a telescopic leg second end (220 for the first extendable leg and 320 for the second extendable leg). Similarly, one or both of the first caster (450A or 550A) and the second caster (450B and 550B) may be attached to or connected to a foot bottom surface (440 for the first foot and 540 for the second foot). As shown in FIG. 6, the first caster may be attached to or connected to the foot bottom surface proximate to the respective foot first end (410 for the first foot and 510 for the second foot) while the second caster may be attached to or connected to the foot bottom surface proximate to the respective foot second end (420 for the first foot and 520 for the second foot).

As further shown in FIG. 6, at least one of the first pair of casters (450A and 450B) may comprise a first lock mechanism (455). Similarly, at least one of the second pair of casters (550A and 550B) may comprise a second lock mechanism (555). The first lock mechanism and the second lock mechanism are not considered necessary, and the arrangement of which casters comprises a lock mechanism is not considered important. In some embodiments, only the first caster (450A) in the first pair of casters may comprise a first lock mechanism. In other embodiments, only the second caster (450B) in the first pair of casters may comprise a first lock mechanism. In still other embodiments, both the first caster (450A) and the second caster (450B) in the first pair of casters may comprise a first lock mechanism. In still other embodiments, neither of the first caster (450A) or the second caster (450B) in the first pair of casters may comprise a first lock mechanism. Similarly, in some embodiments only the first caster (550A) in the second pair of casters may comprise a second lock mechanism. In other embodiments, only the second caster (550B) in the second pair of casters may comprise a second lock mechanism. In still other embodiments, both the first caster (550A) and the second caster (550B) in the second pair of casters may comprise a second lock mechanism. In still other embodiments, neither of the first caster (550A) or the second caster (550B) in the second pair of casters may comprise a second lock mechanism.

When used, the lock mechanism may have two positions known as a locked position and an unlocked position. When in the locked position, the lock mechanism frictionally engages with a rolling portion of the respective caster, thereby preventing said rolling portion of the caster from turning along its axis, or at least increasing the amount of force necessary to cause said rolling portion to turn along its axis. When in the unlocked position, the lock mechanism disengages from the rolling portion of the respective caster, thereby allowing said rolling portion of the caster to turn along its axis. Once the lock mechanism(s) have been disengaged such that the rolling portion of each of the casters can turn along their individual axes, the table can then be easily moved from one location to another, often by a single individual using a pushing or pulling force, with the casters rolling along a floor or other surface. This represents an improvement over existing height adjustable tables having no casters which can only be moved by physically lifting the table, often by two or more persons, in order to move the table from one location to another resulting in inconvenience and increased risk of injury to the operator/mover.

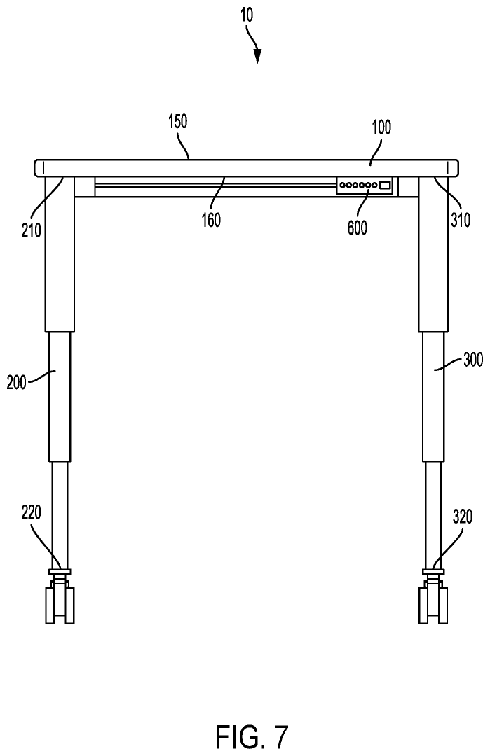

FIG. 7 depicts a front view of an embodiment of a table having three stage telescopic legs. That is to say that the first extendable leg (200) and the second extendable leg (300) are each a three stage telescopic leg. In other words, each of the first extendable leg and the second extendable leg are made of a first section which is longitudinally nested inside a second section which is longitudinally nested inside a third section.

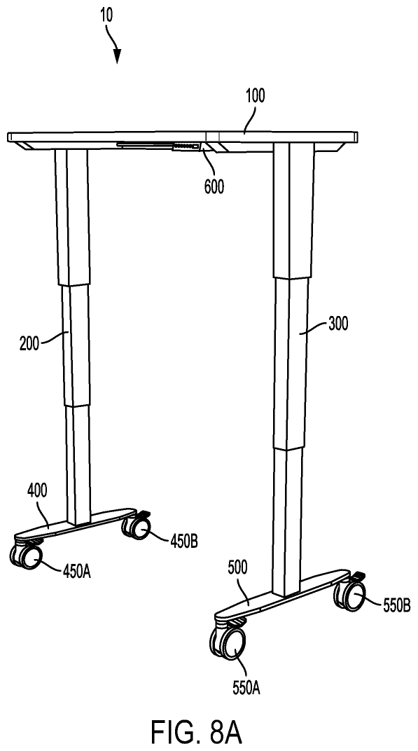

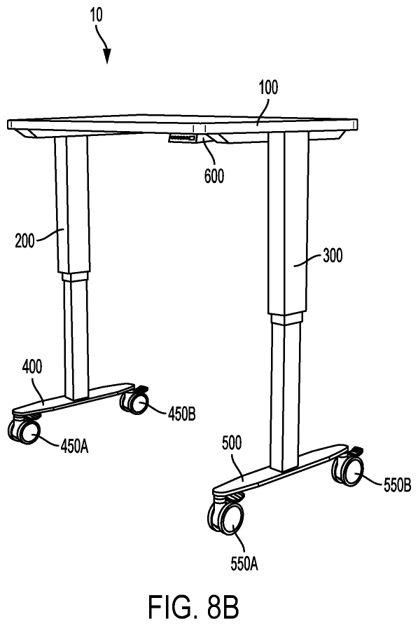

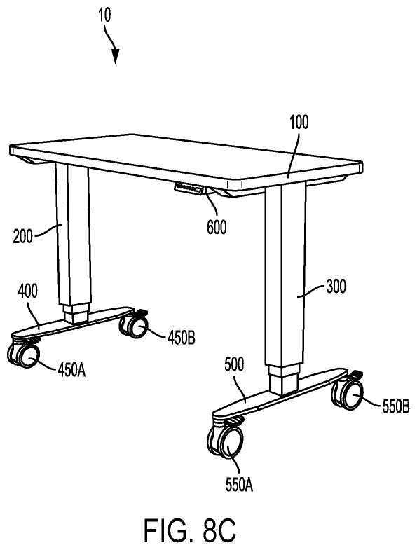

FIG. 8A to 8C show perspective views of the embodiment of a table having three stage telescopic legs in various positions. For example, FIG. 8A shows the first extendable leg (200) and the second extendable leg (300) in a fully extended position, also known as a raised position. FIG. 8B shows the first extendable leg and the second extendable leg in a partially extended position, also known as an intermediate position. In FIG. 8B, the second section of the three stage telescopic legs is fully nested inside the first section while the third section of the three stage telescopic legs is fully extended from the second section. FIG. 8C shows the first extendable leg and the second extendable leg in a fully retracted position, also known as a lowered position. In FIG. 8C, the second section of the three stage telescopic legs is fully nested inside the first section and the third section of the three stage telescopic legs is fully nested inside the second section. One of ordinary skill will recognize that the first extendable leg and the second extendable leg can be in any number of intermediate positions between the fully retracted position and the fully extended position by interrupting the electrical signal between the linear actuator(s) and the control assembly at any point when the linear actuator is not fully extended but is also not fully retracted.

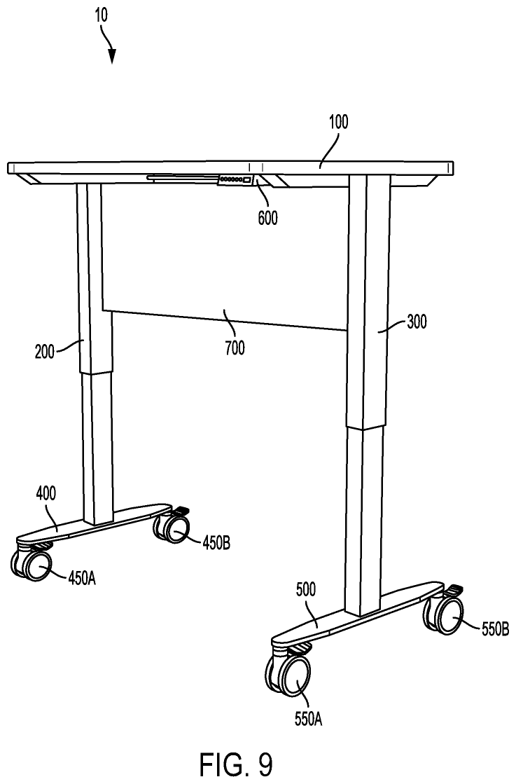

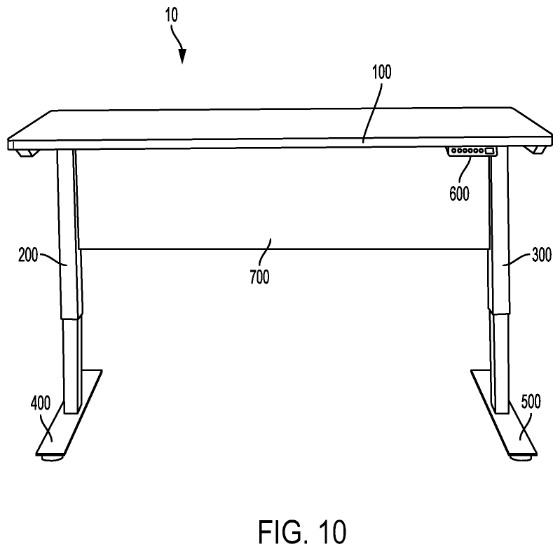

FIG. 9 depicts one embodiment of a table. As shown in FIG. 9, the table may further comprise a modesty panel (700). The modesty panel spans a distance between the first extendable leg (200) and the second extendable leg (300) and may be connected to or attached to the first extendable leg and the second extendable leg. Preferably, the modesty panel will be connected to or attached to the first section of each respective telescopic leg. In some embodiments, the modesty panel may abut against the bottom surface (160) of the panel. FIG. 10 shows a front view of an embodiment of a table having a modesty panel.

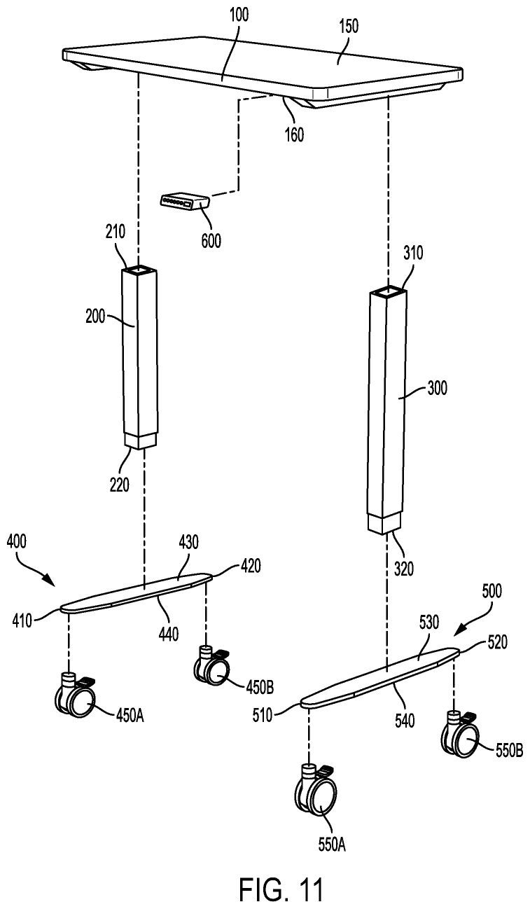

FIG. 11 depicts an exploded perspective view of a table. As shown in FIG. 11, the control assembly (600) connects to the bottom surface (160) of the panel. Similarly, the first extendable leg first end (210) and the second extendable leg first end (310) each connect to the bottom surface of the panel. As further shown in FIG. 11, the first extendable leg second end (220) connects to or attaches to a first foot top surface (430) while the second extendable leg second end (320) connects to or attaches to a second foot top surface (530). FIG. 11 also shows a first pair of casters (450A and 450B) with the first caster (450A) of the first pair of casters connecting to the first foot bottom surface (440) at the first foot first end (410) of the first foot and the second caster (450B) of the first pair of casters connecting to the bottom surface of the first foot at the first foot second end (420). Similarly, FIG. 11 shows a second pair of casters (550A and 550B) with the first caster (550A) of the second pair of casters connecting to the second foot bottom surface (540) at the second foot first end (510) and the second caster (550B) of the second pair of casters connecting to the bottom surface of the second foot at the second foot second end (520).

From the exploded perspective view of a table shown in FIG. 11, one of ordinary skill can form a table kit. The table kit may comprise a panel (100), a first extendable leg (200), a second extendable leg (300), a first foot (400), a second foot (500), a first pair of casters (450A and 450B), a second pair of casters (550A and 550B), and a control assembly (600). The control assembly may comprise a battery, a plurality of capacitive touch keys (620), and a printed circuit board electrically connected to the battery. The plurality of capacitive touch keys may be arranged on the printed circuit board. At least one of the first extendable leg and the second extendable leg in the kit may comprise a linear actuator. In some embodiments, of the kit, both the first extendable leg and the second extendable leg may comprise a linear actuator.

In some embodiments of the kit, at least one of the first pair of casters may comprise a first lock mechanism as described herein. In some embodiments of the kit, at least one of the second pair of casters may comprise a second lock mechanism as described herein.

In some embodiments of the kit, the first extendable leg and the second extendable leg may each be a two stage telescopic leg as described herein. In some embodiments of the kit, the first extendable leg and the second extendable leg may each be a three stage telescopic leg as described herein.

In some embodiments, the kit may further comprise a modesty panel as described herein. In some embodiments, the kit may further comprise an anti-collision device as described herein.

In some embodiments, the table may further comprise an anti-collision device. The anti-collision device operates much the same as an anti-collision sensor in a garage door, and stops the lowering of the panel by the linear actuator(s) when an obstruction, such as a child or a pet, is detected beneath the panel. The anti-collision device may be included in the linear actuator(s). The anti-collision device may be programmed by the control assembly.

In some embodiments (not shown), the table and/or the table kit may further comprise a third extendable leg. The third extendable leg may have a third extendable leg first end and a third extendable leg second end opposite the third extendable leg first end. When used in the table, the third extendable leg first end may be connected to the bottom surface of the panel adjacent to the third edge.

In some embodiments comprising a third extendable leg, the table and/or the table kit may further comprise a third foot. When used in the table, the third foot may have a third foot first end, a third foot second end opposite the third foot first end, a third foot top surface, and a third foot bottom surface. The third foot may further comprise a third pair of casters connected to the third foot bottom surface and located at the third foot first end and the third foot second end respectively. When used in the table, the third extendable leg second end may be connected to or attached to the third foot top surface. The third extendable leg may be either a two stage telescopic leg or a three stage telescopic leg as described herein. In some embodiments utilizing a third extendable leg, the third extendable leg may further comprise a linear actuator. The linear actuator may comprise a third motor which drives the extension or retraction of the third extendable leg.

What is claimed is:

1. A table (10) comprising:
a panel (100) comprising a first edge (110), a second edge (120) opposite the first edge, a third edge (130) extending from the first edge to the second edge, a fourth edge (140) opposite the third edge and extending from the first edge to the second edge, a top surface (150), and a bottom surface (160) opposite the top surface;
a first extendable leg (200) having a first extendable leg first end (210) and a first extendable leg second end (220) opposite the first extendable leg first end;
a second extendable leg (300) having a second extendable leg first end (310) and a second extendable leg second end (320) opposite the second extendable leg first end;
a first foot (400) having a first foot first end (410), a first foot second end (420) opposite the first foot first end, a first foot top surface (430), a first foot bottom surface (440), and a first pair of casters (450A and 450B) connected to the first foot bottom surface and located at the first foot first end and the first foot second end respectively;
a second foot (500) having a second foot first end (510), a second foot second end (520) opposite the second foot first end, a second foot top surface (530), a second foot bottom surface (540), and a second pair of casters (550A and 550B) connected to the second foot bottom surface and located at the second foot first end and the second foot second end respectively; and
a control assembly (600) comprising a battery, a plurality of capacitive touch keys (620), and a printed circuit board electrically connected to the battery wherein the plurality of capacitive touch keys are arranged on the printed circuit board,
wherein the first extendable leg first end is connected to the bottom surface adjacent to the first edge, the second extendable leg first end is connected to the bottom surface adjacent to the second edge, the first extendable leg second end is connected to the first foot top surface, the second extendable leg second end is connected to the second foot top surface, and at least one of the first extendable leg and the second extendable leg further comprises a linear actuator electrically connected to the battery.

2. The table of claim 1, wherein at least one of the first pair of casters comprises a first lock mechanism (455).

3. The table of claim 1, wherein at least one of the second pair of casters comprises a second lock mechanism (555).

4. The table of claim 1, further comprising a modesty panel (700) spanning a distance between the first extendable leg and the second extendable leg.

5. The table of claim 1, wherein the linear actuator further comprises an anti-collision device programmed by the control box.

6. The table of claim 1, wherein each of the first extendable leg and the second extendable leg comprises a separate linear actuator electrically connected to the battery.

7. The table of claim 1, wherein the first extendable leg and the second extendable leg are each a two stage telescopic leg.

8. The table of claim 7, wherein the linear actuator comprises a first motor.

9. The table of claim 1, wherein the first extendable leg and the second extendable leg are each a three stage telescopic leg.

10. The table of claim 9, wherein the linear actuator comprises a first motor and a second motor.

11. The table of claim 1, further comprising a third extendable leg having a third extendable leg first end and a third extendable leg second end opposite the third extendable leg first end wherein the third extendable leg first end is connected to the bottom surface adjacent to the third edge.

12. The table of claim 11, further comprising a third foot having a third foot first end, a third foot second end opposite the third foot first end, a third foot top surface, a third foot bottom surface, and a third pair of casters connected to the third foot bottom surface and located at the third foot first end and the third foot second end respectively wherein the third extendable leg second end is connected to the third foot top surface.

13. A table kit comprising:
a panel;
a first extendable leg;
a second extendable leg;
a first foot;
a second foot;
a first pair of casters;
a second pair of casters; and
a control assembly comprising a battery, a plurality of capacitive touch keys and a printed circuit board electrically connected to the battery,
wherein at least one of the first extendable leg and the second extendable leg comprises a linear actuator, and the plurality of capacitive touch keys is arranged on the printed circuit board.

14. The table kit of claim 13, wherein each of the first extendable leg and the second extendable leg comprises a separate linear actuator.

15. The table kit of claim 13, wherein at least one of the first pair of casters comprises a first lock mechanism.

16. The table kit of claim 13, wherein at least one of the second pair of casters comprises a second lock mechanism.

17. The table kit of claim 13, wherein the first extendable leg and the second extendable leg are each a two stage telescopic leg.

18. The table kit of claim 13, wherein the first extendable leg and the second extendable leg are each a three stage telescopic leg.

19. The table kit of claim 13, further comprising a modesty panel.

20. The table kit of claim 13, wherein the linear actuator further comprises an anti-collision device.
